(19) United States
(12) Patent Application Publication
(10) Pub. No.: US 2014/0125050 A1
(43) Pub. Date: May 8, 2014

(54) Sheet Document having a Translucent or Transparent Region

(71) Applicants: Ralf Liebler, Schliersee (DE); Josef Riedl, Attenkirchen (DE)

(72) Inventors: Ralf Liebler, Schliersee (DE); Josef Riedl, Attenkirchen (DE)

(73) Assignee: GIESECKE & DEVRIENT BMBH, Munich (DE)

(21) Appl. No.: 14/125,122

(22) PCT Filed: Jun. 11, 2012
(86) PCT No.: PCT/EP2012/002464

§ 371 Date: Dec. 10, 2013

(30) Foreign Application Priority Data
Jun. 10, 2011 (DE) 102011103995.7

(51) Int. Cl. B42D 15/00

(52) U.S. Cl. CPC B42D 15/0013
USPC 283/85

(57) ABSTRACT

A sheet document is based on a one-pieced, coextruded composite strip layer having a thickness of 10 to 110 μm defining over its area at least two different materials that are configured side by side as strips. At least one of the strips is transparent or translucent and at least one strip opaque. On the composite strip layer there is applied an ink-receiving layer and/or a printed pattern that has a recess that at least partly is configured above a transparent/translucent strip and together with the non-covered region of the transparent/translucent strip forms a window.

The invention relates to thin, foil-like bodies that have at least an opaque and a transparent or translucent region. The invention relates in particular to sheet documents in the form of bank notes or identification documents of all kinds, which are provided with security elements for proving authenticity and which have a window or a translucent region. The invention further relates to a method for manufacturing a sheet document.

From WO 2009/153056 A2 there is known the proposal to construct data carriers by means of coextruded plastic foils that consist of strips configured side by side having different material properties. The strips can be executed in particular in alternating opaque and transparent fashion. By arranging two such foils crosswise one above the other there can be produced windows in the form of transparent regions as well as regions having different opacities. Regarding the thickness of the manufacturable data carriers a lower limit of 80 μm is stated. The integration into an electronic identification book is proposed as a possible employment for the data carrier. The print also generally suggests to provide the foils with security features. But it does not state any details in this regard. In particular it does not elaborate on the possible importance of a window as a security element. From the print there is further known the proposal to print the surface of a card body constructed by means of the described plastic foils such that by the printing there arise window regions. Position and size of these window regions are independent of the position of the strips in the plastic foil. With very thin data carriers having thicknesses of under 110 μm, however, there arises the problem upon the implementation of the known solution that it is increasingly difficult for deeply opaque strips to be manufactured; accordingly, the contrast between transparent and opaque becomes increasingly weaker. For forming windows in very thin data carriers it is therefore regularly more expedient to print a completely transparent core foil and to produce windows by gaps in the print than to use comparatively more expensive coextruded plastic foils having strips and to print these.

It is the object of the invention to equip bodies, whose body is below the thickness addressed in the above-mentioned WO 2009/153056 A2, with a window or a translucent region that clearly stands out from the remaining part of the body.

This object is achieved by a sheet document having the features of claim 1. The sheet document according to the invention is characterized in that it has a transparent or translucent region, in which a window is configured, on the one hand, and that outside the transparent or translucent region it has a high opacity, on the other hand, thereby the transparent or translucent region being clearly delimited from the remaining parts of the sheet document and accordingly clearly perceptible. By the clearly defined transition between transparent or translucent and opaque regions it becomes possible to use the transition in targeted fashion for checking purposes. By the clear separation there additionally arise new possibilities in the arrangement and in the configuration of security elements.

The invention is based on the finding that by overlaying a print and an opaque strip in targeted fashion there can be achieved a high opacity that clearly contrasts with a bordering transparent or translucent region. According to the invention there is thus applied above a transparent strip a printed pattern that has a recess forming a window. At least one edge of the window is here executed preferably in exact flush fashion with a subjacent borderline between a transparent/translucent strip and an opaque strip.

The sheet document according to the invention is well manufacturable advantageously without particular additional effort. In preferred implementation, exactly one composite strip layer is employed for the sheet document. By choosing suitable materials for the individual strips of the composite strip layer, a plurality of material combinations can be realized on the surface of the sheet document. In particular also difficult materials can thus be processed. Furthermore, the employment of composite strip foils advantageously allows to produce, in addition to windows, also tactile features by providing gaps in opaque strips. An exemplary embodiment of the invention will hereinafter be explained more closely with reference to the drawing.

In an advantageous realization the sheet document according to the invention has at least one transparent intermediate layer applied over the full area, which carries a security feature that becomes visible in the window.

There are shown:

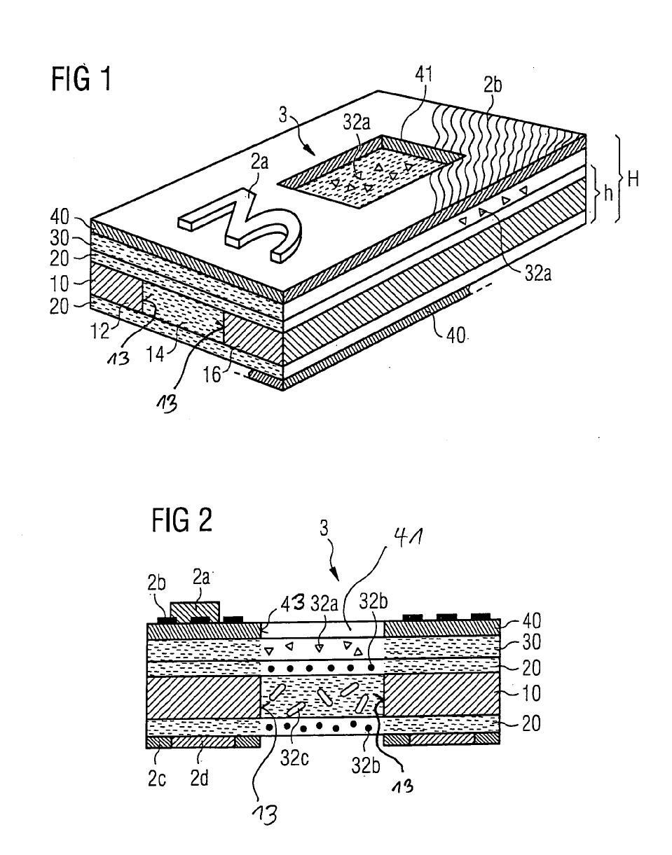

FIG. 1 an oblique plan view of an embodiment of a sheet document,

FIG. 2 a cross section through an embodiment of a sheet document,

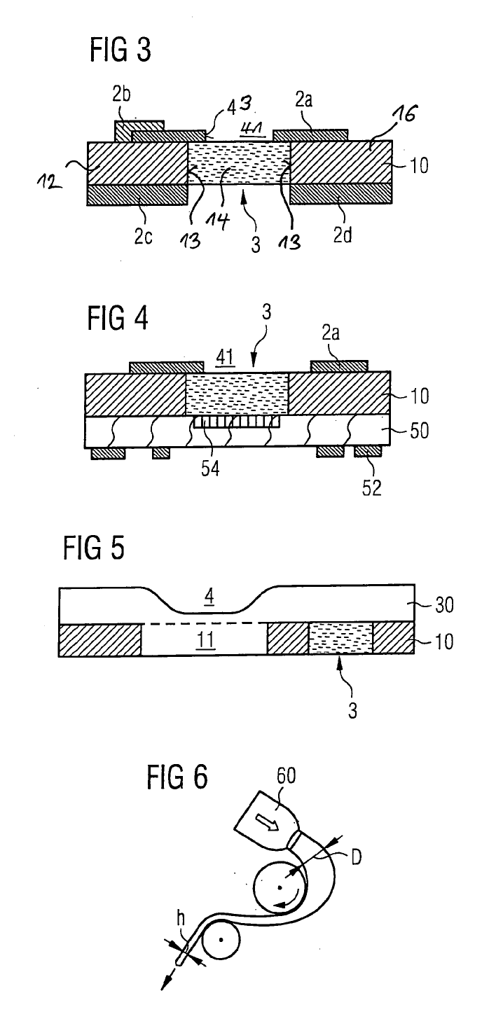

FIG. 3 a cross section through a reduced embodiment of a sheet document,

FIG. 4 a cross section through an alternative embodiment of a sheet document,

FIG. 5 a cross section through an embodiment of a sheet document having a tactile feature and

FIG. 6 the basic construction of an arrangement for stretching a composite strip layer.

FIG. 1 illustrates in a perspective oblique plan view an embodiment of a sheet document 1 according to the invention. The sheet document 1 can be a bank note, a deed, an identification document, a page for attachment into a document or passport booklet or another sheet-like value document, which carries information particularly worthy of protection and is protected against copying by security elements.

The sheet document 1 is based on at least one base layer made of plastic material, paper or a mixture of the two, which first is supplied in the form of a foil or of a web. On the base layer at least one further layer is regularly applied.

In the embodiment illustrated in FIG. 1 the sheet document 1 consists by way of example of five layers, namely composite strip layer 10, two overlayers 20 enclosing the composite strip layer 10, an intermediate layer 30 and an ink-receiving layer 40. Moreover, the individual layers are not shown true to scale in FIG. 1. The total height H of the layer construction formed by the layers 10, 20, 30, 40 normally lies between 10 and 130 μm.

The layers 10, 20, 30, 40 can be provided with printed patterns 2a, 2b and/or with security elements 32a, 32b. In the example of FIG. 1, for instance a first printed pattern 2a in the form of an alphanumeric character combination as well as a second printed pattern 2b in the shape of an indicated guilloche pattern is applied on the ink-receiving layer 40. As indicated in FIG. 2, the printed patterns 2a, 2b overlap here at least partly, in the example of FIG. 1 the printed pattern 2a lying above the printed pattern 2b. Printed patterns 2c, 2d constructed in like or similar manner and having the same or a different content as/than the printed patterns 2a, 2b are typically also configured on the opposite surface of the sheet document 1, which is on the back-side in the representation of FIG. 1. As indicated in FIG. 2, the printed pattern 2c, 2d can here also consist of complementary partial printed patterns and be directly applied on the overlayer 20. Furthermore, as indicated in FIG. 1, an ink-receiving layer 40 can also be readily provided on the back-side surface. The printed pattern 2c, 2d is then applied onto this.

The sheet document 1 has due to the corresponding design of its layers 10, 20, 30, 40 at least one window 3 in the form of a transparent or translucent region. The window 3 is formed by the interaction of a transparent or translucent region of the composite strip layer 10 with a recess 41 or a transparent region in the ink-receiving layer 40 and/or a corresponding design of the printed pattern 2a, 2b or 2c, 2d.

The base layer of the sheet document 1 represented in FIG. 1 is a composite strip layer 10, 10 to 110 μm thick, that is executed as a plastic layer manufactured by coextrusion. In the composite strip layer 10 the strips 12, 14, 16 made of different materials are configured such that they abut each other at lateral border areas 13 and lie side by side over the area of the composite strip layer 10; on the surface of the composite strip layer 10 the border areas 13 appear as corresponding borderlines. In the embodiment according to FIG. 1, the composite strip layer 10 consists of three strips 12, 14, 16 made of different materials, with a center strip 14 being formed by a transparent or translucent material, while the strips 12 and 16 respectively bordering at the longitudinal sides consisting of an opaque material.

The strips 12, 14, 16 may also differ from each other in other material properties, e.g. individual or several strips can be configured to be particularly mechanically stable. Here it may be accepted, where applicable also in targeted fashion, that a certain optimization of a strip 12, 14, 16 with respect to a particular material property leads to an impairment of another material property. For example an improved mechanical stability may lead to a poorer direct printability.

The widths of the strips 12, 14, 16 in the example of FIG. 1 are approximately the same, but may also be designed completely different. Likewise, the composite strip layer 10 in a sheet document 1 may readily have more than three strips or only consist of exactly two strips. The strips 12, 14, 16 of the composite strip layer 10 may further also differ in other properties, besides their opacity, for instance in their suitability for connection with another applied material or in the addition of additives. Among other things, in one or several of the strips 12, 14, 16 there may be incorporated additives that serve as authenticity features or security elements, such as e.g. fluorescent or metallic particles or mottling fibers. In particular in the transparent strip 14 there can be incorporated security elements 32c that are recognizable through the window 3.

All extrudable polymers, such as polyesters, polyolefins, polyamides, PVC, polystyrene, polymethylmethacrylates, polycarbonate, copolymers or mixtures thereof, come into consideration as starting plastic materials for the composite strip layer 10 or for the individual strips 12, 14, 16. The manufacturing of composite strip foils by coextrusion is per se known and described e.g. in WO 2007/118828 A1, to which reference is expressly made herein to this extent.

The overlayers 20 stabilize the composite strip layer 10. Expediently, they are configured as thin, transparent layers and manufactured together with the composite strip layer 10 in the course of the coextrusion. The overlayers 20, individually or both, can be provided with security elements 32b, e.g. fluorescent or metallic particles, mottling fibers or pigments. The overlayers 20 basically are optional layers and may accordingly also be omitted. The further layer constructions are then effected directly onto the composite strip layer 10. Likewise, security threads can be embedded in the overlayers 20, e.g. during the coextrusion process, preferably in those regions, in which the composite strip layer 10 is transparent.

Expediently, the sheet document 1 includes exactly one composite strip layer 10; in a variant also several composite strip layers 10 designed in like manner can lie congruently one above the other and be connected.

The intermediate layer 30 is a preferably transparent plastic foil, which e.g. expediently is applied over the full area onto the composite strip layer 10 after the coextrusion by lamination or by adhesive bonding; it serves in particular as a carrier for security elements 32a. The security elements 32a can be e.g. fluorescent or metallic particles, transfer strips, security threads, mottling fibers or pigments. They can be worked into the intermediate layer 30, as indicated in FIG. 2, or also be applied e.g. by printing technology on the upper or the lower side of the intermediate layer.

In an advantageous implementation, the security elements 32a are elements directly perceptible to the human eye and therefore configured in the intermediate layer 30 in such a region or in such regions that later lie in a recess 41 and preferably above a transparent strip 14 of the composite strip layer. In particular with regard to detection by checking devices, however, security elements 32a can also be configured in other regions of the intermediate layer 30. It is readily also possible to create different security elements 32a in different regions of the intermediate layer 30. In contrast to that what is indicated in FIG. 2, in a particularly simple implementation the security elements 32a can also be simply distributed uniformly over the entire intermediate layer 30.

Preferably, the security elements 32a, 32b and 32c of the overlayer 20 or of the composite strip layer 10 and of the intermediate layer 30 deliver at least one effect, which arises only by a combination of at least the security elements 32a, 32b, 32c and whose recognizability means that at least the involved security elements 32a, 32b, 32c are reliably present. Possible combination effects of this kind are e.g. see-through registers, incident-light effects or transmitted-light effects.

Furthermore, the intermediate layer 30, likewise, is basically optional and may accordingly also be omitted. Likewise, however, also two or more intermediate layers 30 can be provided, it being possible for these to carry different security elements 32a.

The ink-receiving layer 40—outside the recess 41—is typically opaque and is expediently printed. It enters into a particularly good connection with applied printed patterns 2a, 2b. The ink-receiving layer 40 may contain for this purpose specific additives, e.g. diatomaceous earth, in order to improve the ink reception. At the desired places, i.e. in particular in the recess 41, the otherwise opaque ink-receiving layer 40 is preferably steplessly left open. In variants, the ink-receiving layer 40 can also be transparent over the full area or partly opaque and partly transparent, in particular above the transparent strips 14 of the composite strip layer 10.

One or, as indicated in FIG. 1, several printed patterns 2a, 2b are applied by printing technology on the ink-receiving layer 40. The printed patterns can in particular be, as indicated in FIG. 1, a security pattern such as a guilloche pattern, or alphanumeric information for instance numerical data. The printed patterns 2a, 2b can be executed, as apparent from FIG. 2, one above the other or overlapping, for instance in such a way that onto a guilloche pattern 2b executed by means of a first ink there is applied alphanumeric information 2a executed by means of a different ink. The printing inks used for producing the printed patterns 2a, 2b expediently are coordinated to the ink-receiving layer 40 such that an intimate connection between printed pattern 2a, 2b and ink-receiving layer 40 arises.

In the ink-receiving layer 40 there is provided, as shown in FIG. 1, a recess 41, which in the finished sheet document 1 forms together with the further layers 10, 20, 30 a window 3. The recess 41 is rectangular-shaped and placed such that it lies completely above the center transparent strip 14 of the composite strip layer 10. As it is apparent from FIG. 2, the recess 41 expediently lies exactly such that the inner edges 43 extending in the direction of the strips 12, 14, 16 are exactly flush with the two borderlines 13 between the transparent strips 14. In this way the opacity difference between the window 3 and the bordering region of the sheet document 1 is strengthened and the transition between the window 3 and the bordering parts of the sheet document 1 becomes clearly recognizable due to the contrast and/or color difference. The recognizability is so clear that it can be effected by machine. The recess 41 interrupts the printed patterns 2a, 2b and in the embodiment according to FIG. 1 allows the viewing of security elements 32a configured in the subjacent intermediate layer 30 and/or the overlayer 20. Of course, the recess 41 can be larger dimensioned, so that it also covers parts of the opaque strips 12, 16 of the composite strip layer 10 or allows the viewing thereof. There can also be provided several recesses 41, which can be arranged above the transparent strip 14 as well as above the opaque strip 12, 16 of the composite strip layer. The contour of the recesses 41 is not restricted to rectangular shapes, as indicated in FIG. 1, but can be designed as desired and may have for instance a cloud contour.

The arrangement of the layers 10, 20, 30, 40 is preferably effected such, as apparent in particular from FIG. 2, that the recess 41, the security elements 32a, 32b and the transparent strip 14 of the composite strip layer lie exactly one above the other, so that in plan viewing, as indicated in FIG. 2 by the arrow, there arises a window 3 that is recognizable as such to the unarmed eye of a user and usable as such. In preferred implementation, at least one security element 32a, 32b lies in the window 3, so that a user can directly check it.

While the window 3 formed by the recess 41 appears transparent or at least translucent, the sheet document's 1 regions covered by the ink-receiving layer 40 possess a particularly high opacity, primarily where the ink-receiving layer 40 lies above an opaque strip 12, 16 of the composite strip layer 10. As the ink-receiving layer 40 and opaque strips 12, 16 of the composite strip layer 10 strengthen each other in their opacity, there arises a high opacity for these overlaid regions already at a very small layer thickness of the composite strip layer 10. In particular upon employment as a bank note, a sheet document 1 can thus be supplied, which with a small thickness H simultaneously has a high opacity and a window 3.

In a variant illustrated in FIG. 3 that is reduced compared to the embodiment shown in FIG. 1, overlayers 20, intermediate layer 30 and ink-receiving layer 40 are omitted and on the composite strip layer 10 printed patterns 2a, 2b or 2c, 2d are directly applied. By said layers 20, 30, 40 being omitted and the direct application of the printed patterns 2a, 2b or 2c, 2d on the composite strip layer 10, the thickness H of the sheet document 1 can be further reduced.

In the variant according to FIG. 3, the recess 41 and thus the window 3 is defined by the printed patterns 2a, 2b, 2c, 2d. As they are directly connected with the printed pattern 2a, 2b, the strips 12, 14, 16 of the composite strip layer can be advantageously coordinated to the printed patterns 2a, 2b, 2c, 2d. The coordination can here be effected with regard to the optical content of the printed patterns 2a, 2b, 2c, 2d, on the one hand, i.e. with regard to colors and forms of the printed patterns 2a, 2b, 2c, 2d. For instance opaque strips 12, 16 can be executed in colors, which clearly contrast with the parts of the printed patterns 2a, 2b, 2c, 2d applied on these strips 12, 16 or which posses a coloring of the same kind.

Furthermore, the coordination can also be effected such that e.g. on certain strips 12, 14, 16 there can be printed inks, which without a particular preparation of the base would not sufficiently adhere. E.g. a strip, for instance the transparent strip 14, can be provided with specific additives, which make it possible that the such prepared strip 14 can be printed with inks particularly rich in pigments; inks rich in pigments due to their high pigment content normally adhere poorly.

Furthermore, the position of the recesses 41 formed by the printed patterns 2a, 2b, 2c, 2d in relation to the borderlines 13 between the strips 12, 14, 16 can be varied. For example, as indicated in FIG. 3, the inner edges 43 of a recess 41—in FIG. 3 those of the above one—may slightly protrude beyond the borderlines 13.

In particular in the transparent strips 14 there can further be incorporated security elements 32a that are recognizable through the recess 41.

In further implementation variants of the sheet document 1 shown in FIG. 1, it is possible to apply over the printed pattern 2a, 2b one or several further layers—not shown—, which serve e.g. as a protective layer. Of course, in addition, the two sides of the composite strip layer 10 can be executed completely symmetrically in contrast to that what is indicated in FIGS. 1 and 2. In a further variant it is also possible to employ two, instead of one, or more composite strip layers 10, with at least two composite strip layers 10 expediently being arranged crosswise one above the other, so that a defined, rectangular-shaped, transparent or translucent region arises.

FIG. 4 shows an embodiment of a sheet document, in which a reduced layered composite consisting only of composite strip layer 10 and a printed pattern 2a directly applied on the upper side is applied on a carrier layer 50 made of paper. On its upper side facing downward in FIG. 4 the carrier layer 50 is provided with a printed pattern 52, which similar to the printed pattern 2a, 2b can form alphanumeric information and/or a security pattern. Furthermore, the carrier layer 50 has a watermark 54.

The layered composite made of composite strip layer 10 and printed pattern 2a again has a window 3 on its upper side, which window is formed by a recess 41 produced in the printed pattern 2a and a transparent strip 14 lying one above the other. The window 3 is placed above the watermark 54, so that the watermark 54 can be recognized well from both sides of the sheet document 1. Simultaneously, the regions outside the window 3 have a particularly good opacity, so that here e.g. printed patterns 52 configured on the carrier layer 50 are perceptible particularly well. Instead of above watermarks, the window 3 can also be arranged above other security features configured on the carrier layer 50, for instance above security threads or regions with fluorescent, phosphorescent or IR-absorbing elements. Of course, there can also be provided several windows 3 in different sizes and forms, which respectively cover one or several of the security elements or allow the viewing thereof. In a variant, the carrier layer 50 made of paper itself can also have a window opening coordinated to the window 3. Furthermore, it is readily possible to laminate the carrier layer 50 made of paper on both sides to a layered composite made of composite strip layer 10 and printed pattern 2a.

In an expedient variant of the embodiment shown in FIG. 4, on both sides of the composite strip layer 10 there are arranged carrier layers 50 made of paper, so that a symmetric construction arises; both carrier layers 50 can respectively be printed with printed patterns 52. One of the carrier layers 50 is above the window 3 expediently cut out corresponding to the recess 41. On the cut-out side or also on both sides there is further respectively configured a transparent intermediate layer 30, which carries a security feature in the window 3.

In a further embodiment of the sheet document according to the invention, which is illustrated in FIG. 5, this can be further modified such that therein, besides a window 3, additionally also a tactile element 4 arises. FIG. 5 shows a layered composite consisting of a composite strip layer 10 and an intermediate layer 30, the composite strip layer 10 having an opaque strip 12 and a transparent strip 14. The opaque strip 12 possesses a recess 11, which is incorporated e.g. by punching or cutting. The recess 11 can have an arbitrary form and can be e.g. round or rectangular-shaped. The intermediate layer 30, which is lying on the top in FIG. 5, is applied such, that it consistently follows the contour of the composite strip layer 10 with at least approximately constant thickness. In the region of the recess 11 the intermediate layer 30 thus forms a depression, which is perceptible as a tactile element 4. The configuration of such a tactile element 4 can in particular be combined with the simultaneous configuration of a window 3. Onto the tactile element 4 there can be subsequently readily applied an ink-receiving layer 40 and thereon a printed pattern 2, 2a.

FIG. 6 shows in a strongly schematized form a possibility to further reduce the thickness of a composite strip layer 10 after the coextrusion. Directly after exiting the extruder 60 the composite strip layer present in the form of a foil is drawn around a cooled roll 61, thereby the composite strip layer 10 being stretched and its thickness decreasing from an initial value D to an end value h. The magnitude of the end value h here substantially depends on the rotational speed of the roll 61.

1-10. (canceled)

11. A sheet document comprising a one-pieced, coextruded composite strip layer having a thickness of 10 to 110 μm, which includes over its area at least two different materials that are configured side by side in the form of strips, wherein the composite strip layer has at least one transparent/translucent strip and at least one opaque strip, wherein on the composite strip layer there is applied a printed pattern that is interrupted by at least one recess that lies at least partly above a transparent/translucent strip and together with the non-covered region of the transparent/translucent strip forms a window, wherein at least an inner edge of the recess lies exactly above a subjacent borderline between a transparent/translucent strip and an opaque strip, so that a clearly recognizable transition between a transparent/translucent region of the window and a bordering opaque region arises.

12. The sheet document according to claim 11, wherein on the composite strip layer there is applied an ink-receiving layer that has at least one transparent region or one recess that lies at least partly above a transparent/translucent strip and together with the subjacent or the non-covered region of the transparent/translucent strip forms a window and the printed pattern is applied on the ink-receiving layer.

13. The sheet document according to claim 12, wherein the ink-receiving layer is opaque.

14. The sheet document according to claim 11, wherein a transparent intermediate layer is arranged between the composite strip layer and a ink-receiving layer and/or printed pattern.

15. The sheet document according to claim 14, wherein the intermediate layer carries a security element whose position is coordinated to the position of the window.

16. The sheet document according to claim 11, wherein an overlayer is configured on at least one side of the composite strip layer.

17. The sheet document according to claim 11, wherein a recess is configured in an opaque strip of the composite strip layer, which recess forms a tactile element.

18. The sheet document according to claim 11, wherein a strip of the composite strip layer carries a security element.

19. The sheet document according to claim 11, wherein it has two composite strip layers that are arranged crosswise one above the other.

20. A method for manufacturing a composite strip layer for a sheet document according to claim 11, wherein a composite strip layer is manufactured by coextrusion and this is subsequently stretched by drawing.
